(19) United States
(12) Patent Application Publication
(10) Pub. No.: US 2012/0189809 A1
(43) Pub. Date: Jul. 26, 2012

(54) LAMINATED FOAM PAD

(76) Inventor: David HENSON, Belden, MS (US)

(21) Appl. No.: 13/027,692

(22) Filed: Feb. 15, 2011

Related U.S. Application Data
(60) Provisional application No. 61/434,596, filed on Jan. 20, 2011.

(51) Int. Cl. B32B 27/08; B31B 1/60

(52) U.S. Cl. 428/141; 156/222

(57) ABSTRACT

A bottom polyurethane foam slab is adhered to a middle viscoelastic foam slab that, in turn, is adhered to a top polyurethane foam slab to form a laminated foam block that is fed between rollers of a convoluting machine to form a pair of complementary convoluted laminated foam pads having laminated projections with parts of different density.

### CROSS REFERENCE TO RELATED APPLICATION

This application claims the benefit of U.S. Provisional Patent Application Serial No. 61/434,596, filed Jan. 20, 2011.

### BACKGROUND OF THE INVENTION

The present invention generally relates to a laminated foam pad, especially a mattress topper, having foam portions of differing stiffnesses or densities, as well as a method of making the laminated foam pad.

### DESCRIPTION OF THE RELATED ART

Historically, mattresses have been filled with a variety of natural materials, including straw, a solid pack of hair, cotton-wool and feathers. Modern mattresses usually contain an inner spring core and/or materials such as rubber, latex or viscoelastic-type or other polyurethane-type foams. Such foam materials, preferably configured as a thick or thin foam pad having a top surface contoured with convolutions or raised and lowered areas extending over part or the entire top surface of the foam pad, have been found to have certain desirable qualities such as durability, resistance to packing and lumping, comfort, and a desired resilience.

However, the entire foam pad is made of a single piece construction with the same density of foam throughout. The qualities of the pad, such as comfort and resilience, could be enhanced if the pad had foam portions of differing stiffnesses or densities.

### SUMMARY OF THE INVENTION

According to one feature of this invention, a bottom polyurethane foam slab is adhered in surface area contact to a middle viscoelastic foam slab that, in turn, is adhered in surface area contact to a top polyurethane foam slab to form a laminated foam block that is fed between rollers of a convoluting machine. The laminated foam block is sliced lengthwise in a transverse plane midway between the rollers to form a pair of complementary convoluted laminated foam pads, each having a dimpled surface resembling an “egg crate” with a plurality of projections and a plurality of depressions arranged in a checkerboard pattern. The depressions on one pad are formed by slicing away foam which become the projections on the other pad. The projections have continuous, sinuous, convex curvatures. The depressions have continuous, sinuous, concave curvatures. Each dimpled surface can be patterned with projections and depressions arranged in patterns other than an egg crate pattern.

Each projection is laminated and is comprised of parts of the three foam slabs. Thus, each projection has a rounded peak constituted of the polyurethane foam material, a core constituted of the viscoelastic foam material, and a base constituted of the polyurethane foam material. Thus, each projection has parts of different density or stiffness to enhance comfort and resilience.

Also, according to another feature of this invention, a method of making a laminated foam pad is performed by adhering an upper layer, which is constituted of a foam material having a predetermined density, in surface area contact with an upper surface of a middle layer that is constituted of a foam material having a density different from the predetermined density; adhering a lower surface of the middle layer in surface area contact with a lower layer that is constituted of a foam material having the same predetermined density as the upper layer, to form a laminated foam block; feeding the laminated foam block between a pair of convoluting rollers having opposed spaced projecting members that compress the laminated foam block; and cutting the compressed laminated foam block into two minor-symmetrical, laminated foam pads, each laminated foam pad having an upper surface with a plurality of raised projections and a plurality of depressions arranged in a pattern, each projection having a peak portion constituted of the foam material having the predetermined density, a core portion constituted of the foam material having the different density, and a base portion constituted of the foam material having the same predetermined density as the peak portion.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a laminated foam block prior to being convoluted and cut into a pair of laminated foam pads according to the method of the present invention;

FIG. 2 is a sectional view of the foam block of FIG. 1 during the convolution and cutting steps according to the method of the present invention; and

FIG. 3 is a cut-away, perspective view of the laminated foam pads after the convolution and cutting steps performed in FIG. 2.

### DETAILED DESCRIPTION OF THE PREFERRED EMBODIMENTS

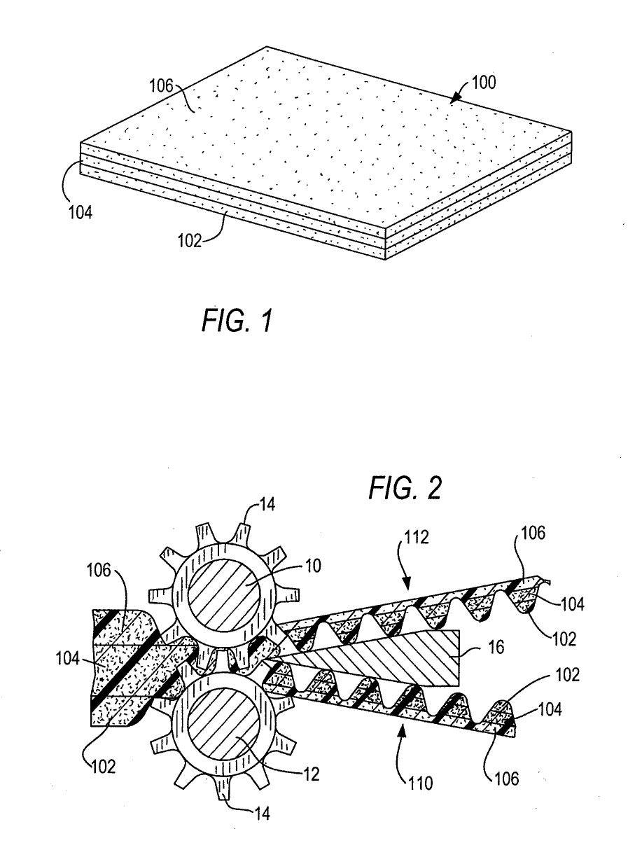

Referring to FIG. 1 of the drawings, a laminated foam block 100, preferably rectangular in shape, includes a bottom foam portion or layer 102 constituted of a rectangular foam material, preferably a polyurethane foam, a middle foam portion or layer 104 constituted of a different rectangular foam material, preferably a viscoelastic foam, and a top foam portion or layer 106 constituted of a rectangular foam material, again preferably a polyurethane foam. Each layer preferably has the same thickness on the order of ¾ of an inch. It will be understood that the layers may be of different thicknesses, and may have different numerical thicknesses. The layers 102, 104, 106 are initially individual, discrete slabs of sheet foam, which are adhered together in surface area contact in a stack by applying a contact adhesive between adjacent surfaces, and then applying pressure on the adjacent slabs to insure a strong adhesive bond therebetween.

The visco-elastic foam, also known as memory foam, of the middle layer 104 has a different density than that of the bottom and top layers 102, 106. Density or firmness (hard to soft) of memory foam is typically measured by a foam's indentation force deflection (IFD) rating. IFD is a measure of the force (in pounds) required to make a dent 1 inch deep into a foam sample 15″×15″×4″ by an 8 inch diameter (50 square inch) disc. IFD ratings for memory foams range between super soft (IFD 10) and semi-rigid (IFD 12) and firm (IFD 12 to IFD 16). The degree of foam firmness at different compressions is affected by density and the particular chemical formulation of the foam. Higher density foams having higher IFD ratings are invariably more satisfactory than lower density foams for the bottom and top layers 102, 106 for the reasons of increased support and decreased fatigue properties.

As shown in FIG. 2, the laminated foam block 100 is fed through a convoluter machine which has a pair of rollers 10, 12 with opposed spaced projecting members 14 arranged in a pattern. As the laminated foam block 100 passes between and is compressed by the rollers 10, 12, the compressed foam block 100 is lengthwise sliced by a blade or saw 16 in a transverse plane midway between the rollers.

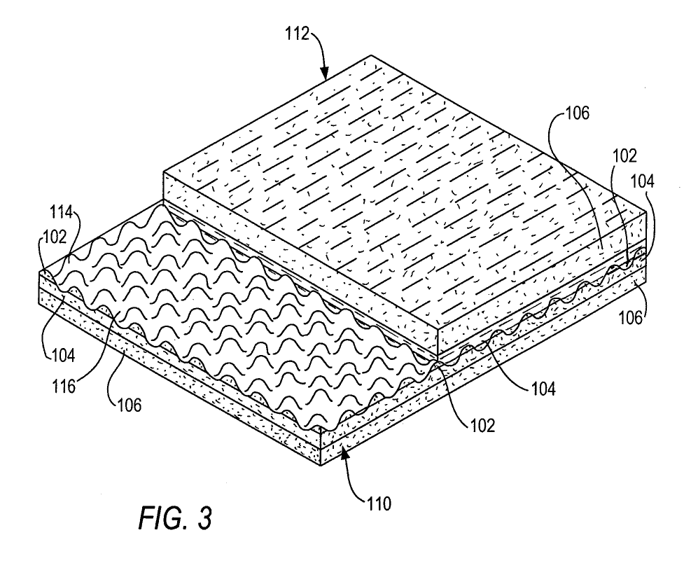

The result is a pair of complementary convoluted laminated foam pads 110, 112 each having a dimpled surface resembling an “egg crate” with a plurality of projections 114 and a plurality of depressions 116 arranged in a checkerboard pattern. The depressions 119 on one pad are formed by slicing away foam which become the projections 114 on the other pad. The projections 114 have continuous, sinuous, convex curvatures. The depressions 116 have continuous, sinuous, concave curvatures. As shown in FIG. 3, the projections 114 of each pad mate into the depressions 116 of the other pad. Each dimpled surface is equally divided between the projections 114 or raised areas and the depressions 116 or lowered areas. Each dimpled surface can be patterned with projections and depressions arranged in patterns other than an egg crate pattern.

Each projection 114 is laminated and is comprised of parts of the three foam portions 102, 104, 106. Thus, each projection 114 has a rounded peak constituted of the foam material 102, a core constituted of the foam material 104, and a base constituted of the foam material 106. Thus, each projection 114 has parts of different density or stiffness.

The three-layered foam block 100 preferably has a thickness, e.g., about three inches, and each pad 110, 112 preferably has a thickness, e.g., about 1½ inches, to advantageously serve as a mattress topper that rests on top of a mattress. Each pad 110, 112 need not only be used for bedding, but could also be used in furniture, such as a sofa or padded chair.

It will be understood that each of the elements described above, or two or more together, also may find a useful application in other types of constructions differing from the types described above.

While the invention has been illustrated and described as embodied in a laminated foam pad and a method of making the same, it is not intended to be limited to the details shown, since various modifications and structural changes may be made without departing in any way from the spirit of the present invention. For example, the outer surface of each pad that is opposite to the dimpled surface need not be flat as illustrated in the drawings, but could also be patterned with a wave shape.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A laminated foam pad, comprising:
a multi-layered foam having an upper surface with a plurality of raised projections and a plurality of depressions arranged in a pattern, each projection having a peak portion constituted of a foam material having a predetermined density, a core portion constituted of a foam material having a density different from the predetermined density, and a base portion constituted of a foam material having the same predetermined density as the peak portion, the peak portion being adhered to, and integral with, the core portion that, in turn, is adhered to, and integral with, the base portion.

2. The laminated foam pad of claim 1, wherein the projections alternate with the depressions entirely across the upper surface of the multi-layered foam.

3. The laminated foam pad of claim 1, wherein each projection has a rounded convex curvature, and wherein each depression has a rounded concave curvature.

4. The laminated foam pad of claim 1, wherein the foam material of each peak portion and each base portion is polyurethane foam, and wherein the foam material of each core portion is visco-elastic foam.

5. A method of making a laminated foam pad, comprising the steps of:
adhering an upper layer, which is constituted of a foam material having a predetermined density, in surface area contact with an upper surface of a middle layer that is constituted of a foam material having a density different from the predetermined density;
adhering a lower surface of the middle layer in surface area contact with a lower layer that is constituted of a foam material having the same predetermined density as the upper layer, to form a laminated foam block;
feeding the laminated foam block between a pair of convoluting rollers having opposed spaced projecting members that compress the laminated foam block; and
cutting the compressed laminated foam block into two minor-symmetrical, laminated foam pads, each laminated foam pad having an upper surface with a plurality of raised projections and a plurality of depressions arranged in a pattern, each projection having a peak portion constituted of the foam material having the predetermined density, a core portion constituted of the foam material having the different density, and a base portion constituted of the foam material having the same predetermined density as the peak portion.

6. The method of claim 5, and alternating the projections with the depressions entirely across each laminated foam pad.

7. The method of claim 5, and forming each projection with a rounded convex curvature, and forming each depression with a rounded concave curvature.

8. The method of claim 5, and constituting the upper and lower layers of polyurethane foam, and constituting the middle layer of visco-elastic foam.
